(19) United States
(12) Patent Application Publication
(10) Pub. No.: US 2007/0186741 A1
(43) Pub. Date: Aug. 16, 2007

(54) TABLE SAW GUARD ASSEMBLY

(76) Inventors: William C. Buck, Clemson, SC (US); David G. Peot, Easley, SC (US)

Correspondence Address: BRINKS HOFER GILSON & LIONE, P.O. BOX 10395, CHICAGO, IL, 60610, US

(21) Appl. No.: 11/691,945

(22) Filed: Mar. 27, 2007

Related U.S. Application Data
(63) Continuation-in-part of application No. 11/516,271, filed on Sep. 5, 2006.
Application No. 11/516,271 is a continuation of application No. 10/601,721, filed on Jun. 23, 2003, now abandoned.

(51) Int. Cl. B26D 7/06; B27B 3/28

(52) U.S. Cl. 83/438; 83/440.2

(57) ABSTRACT

An improved riving knife/guard assembly that provides a viewing slot on a guard top plate to allow for sufficient observation of the cutting zone during table saw operations, while providing protection to minimize the likelihood of contact the rotating saw blade during use.

This application is a continuation-in-part application of co-pending U. S. application Ser. No. 11/516,271, filed on Sep. 5, 2006, which is a continuation application of U. S. application Ser. No. 10/601,721 filed on Jun. 23, 2003, both of which are fully incorporated by reference herein.

### BACKGROUND

Typical table saws include a base or frame having a flat table top or supporting a flat table top. The table top generally includes a slot through which a cutting member, such as a circular saw, protrudes above the table top. Often, a riving knife or splitter is mounted directly in line with the saw blade. The riving knife operates to keep separate the two sides of the portion of the workpiece that has been cut. By keeping the workpiece separated, it reduces the possibility of the workpiece binding as it is cut. Table saws also include a guard to protect the operator from potential serious injury caused by accidental contact with the saw blade. The guard is located in such a way so that it prevents the operator from contacting the saw blade while in use.

Many types of riving knives and guard assemblies have been used in the past. However, these assemblies often at least partially obstruct the operator's view of the workpiece, or the saw blade, or the reference marks or scales used to align the workpiece. As a result, many guards are often removed which in turn results in a higher probability of accidents and injuries. Additionally, the removal of guards from the table saw often requires the use of tools making the adjustment or maintenance of the saw blade and riving knife complicated and difficult.

Accordingly, objects of the present invention include providing a table saw having a riving knife/guard assembly that: provides the operator with protection from the blade; provides a clear view of the cutting or work zone, the workpiece to be cut, the saw blade, and any scale or alignment marks; allows for easy removal and installation of the guard without the use of any tools; that can easily accommodate different size workpieces; and is sturdy.

### BRIEF SUMMARY

An improved riving knife/guard assembly is provided for use with a table saw. The assembly includes a riving knife that is mounted to the table saw frame in line with the saw blade. The riving knife is adjustable directly with the blade so that as the blade height is adjusted to accommodate for different size workpieces, or the blade angle is adjusted for bevel cuts, the riving knife is similarly adjusted.

A guard is attached to the riving knife. The guard is attached to the riving knife using a system of one or more pins that engage slots on the riving knife. The slots can be dogleg shaped and oriented in opposing directions. At least one of the pins is a multi-position pin that can be placed in at least two positions. In one position, the guard is securely and rigidly mounted to the riving knife. In a second position, the guard can be removed from the riving knife.

The guard also can be provided with a viewing slot that allows the operator to see the cutting zone, and/or the workpiece that is being cut, and/or the saw blade, and/or any scale or alignment marks. To further enhance viewing, the guard can be provided with a light or a magnifying lens or both.

The guard may also include a bail. The bail may be pivotally mounted onto the guard top plate. The pivot mounting allows the bail to be raised or lowered and to also be movable to accommodate different size workpieces. The bail may also be two-piece construction. This provides further flexibility for accommodating different size workpieces and bevel cuts.

### BRIEF DESCRIPTION OF THE DRAWINGS

The features and advantages of the present invention may be better understood by reference to the accompanying drawings in which like reference numerals refer to like elements and in which:

FIG. 1 is a perspective view of an exemplary table saw incorporating various features according to the present invention.

FIG. 2 is a side view of a riving knife/guard assembly and saw blade (removed from the table saw) incorporating various features according to the present invention.

FIG. 3 is a top view of a riving knife/guard assembly incorporating various features according to the present invention.

FIG. 4 is a perspective view of an exemplary table saw incorporating various features according to the present invention including a riving knife/guard assembly where the bail is in an up or lifted position.

FIG. 5 is an exploded view of a riving knife/guard assembly incorporating various features according to the present invention.

FIG. 6 is a front view of a portion of a table saw, including the saw blade, table top and riving knife/guard assembly incorporating various features according to the present invention.

FIG. 7 is a bottom view of a riving knife/guard assembly incorporating various features according to the present invention.

FIG. 8 is a perspective view of a riving knife, multi-position pin and second pin incorporating various features according to the present invention.

FIG. 9 is a side view of a riving/knife guard assembly incorporating various features according to the present invention.

FIG. 10 is a front/top view of a guard top plate incorporating various features according to the present invention, including a light and a magnifying lens.

FIG. 11 is a front view of a guard top plate incorporating various features according to the present invention, including chamfered interior surfaces and a chamfered exterior surface.

FIG. 12 is a front view of a guard assembly incorporating various features according to the present invention, including a two piece bail.

FIG. 13a is a perspective view of a first alternate embodiment of the guard top plate of FIG. 1.

FIG. 13b is a top view of the guard top plate of FIG. 13a.

FIG. 14a is a perspective view of a second alternate embodiment of a guard top plate of FIG. 1.

FIG. 14b is a top view of the guard top plate of FIG. 14a.

FIG. 15a is a perspective view of a third alternate embodiment of the guard top plate of FIG. 1.

FIG. 15b is the top view of the guard top plate of FIG. 15a.

FIG. 16a is a perspective view of a fourth alternate embodiment of the guard top plate of FIG. 1.

FIG. 16b is the top view of the guard top plate of FIG. 16a.

FIG. 17 is a side view of the exemplary guard top plate and saw blade of FIG. 1.

FIG. 18 is an alternate side view of the exemplary guard top plate and saw blade of FIG. 1.

### DETAILED DESCRIPTION OF THE DRAWINGS AND THE PRESENTLY PREFERRED EMBODIMENTS

While this invention is susceptible of several different embodiments, this specification and the accompanying drawings disclose only some specific forms as examples of the invention, including the most preferred embodiment. The invention is not intended to be limited by the descriptions in this specification or the drawings. Instead, the scope of the invention is provided in the claims.

FIG. 1 shows a table saw (10) having the improved riving knife/guard assembly (20). The table saw includes a table top (12). The table top (12) includes a slot (14). A saw blade (16) is conventionally mounted to a motor and carriage (both not shown) that is located under the table top (12) along a blade axis (16a). The saw blade (16) protrudes through the slot (14). The portion of the blade (16) that protrudes through the slot (14) is the operative portion for cutting a workpiece (not shown).

A riving knife or splitter (22) is also mounted to the table saw. The riving knife (22) preferably is mounted to the carriage (not shown) under the table top (12) in such a manner so that it is centered behind or aligned with the saw blade (16). Since the carriage is the same as that on which the saw blade (16) is mounted, adjustment of the height or angle of the saw blade (16) will result in an identical adjustment in height or angle to the riving knife (22). Alternatively, the riving knife (22) can be fixedly mounted to a portion of the frame other than the carriage so that the riving knife (22) is not adjustable with the saw blade (16). The riving knife (22) operates to keep the cut portion of the workpiece split or separated after it is cut and as the remainder of the workpiece is fed through the saw blade (16). Splitting or keeping the cut portions of the workpiece separated helps to prevent potential binding of the saw blade (16) during operation. Optimally, the riving knife (22) is spaced approximately ⅛ inch from the saw blade (16) to reduce the possibility for binding and kickback. Additionally, it is preferred that the riving knife (22) be at a height slightly lower than the saw blade (16) height. This allows the riving knife (22) to be left in place for non-through cuts.

A guard (24), as explained in more detail below, is attached to the riving knife (22). The guard includes a housing or guard top plate (26). The guard top plate (26) comes down around the blade (16) to protect the operator from contacting the blade (16). Because the guard (24) is attached to the riving knife (22), the workpiece does not come into contact with the guard top plate (26). The guard top plate (26) preferably has a viewing slot (28) at its front end. The front end is the end where the workpiece is fed into the table saw (10). The viewing slot (28) provides the operator with increased visibility of the work zone or cutting zone as well as the workpiece being cut, the saw blade (16), and any alignment markings or scale (not shown) on the table top (12) in the work zone. The use of alignment markings and a scale are conventional in the table saw industry.

The guard top plate (26) also has interior chamfered edges (30) at its front portion, i.e., the workpiece feed portion of the guard top plate (26). The chamfered edges (30) serve several purposes. The chamfered edges (30) increase the view of the cutting zone, as well as the blade (16) and workpiece, while maximizing the distance from the blade (16) to the operator. Further, they facilitate better light dispersion from an on board light (described below). As shown in FIG. 11, the outside edges (30′) of the guard top plate may also be chamfered. While FIG. 11 only illustrates one outside edge (30′) that is chamfered, both may be chamfered. The chamfered outside edge (30′) helps to maximize the range of useful height for beveled cuts without having to remove the guard (24).

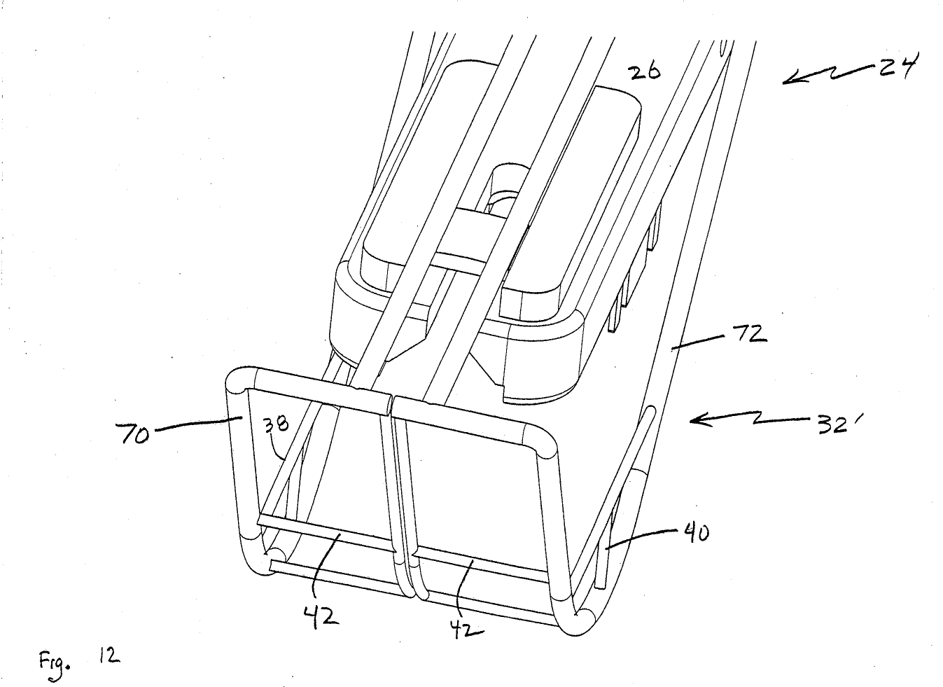

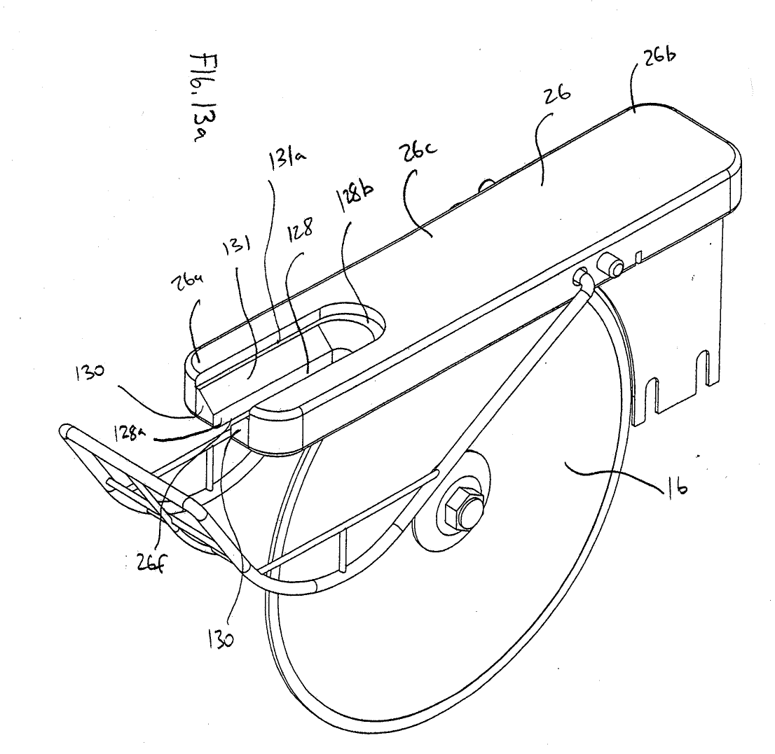

Turning now to the representative embodiments shown in FIGS. 13a-16b, the viewing slot (28) of the guard top plate (26) may be formed with several different geometries. For example, as shown in FIGS. 13a-13b, guard top plate (26) may include a viewing slot (128) that projects inward from a first end (26a) of the guard top plate (26) in parallel to the longitudinal axis (26d) (best shown in FIG. 13b) of the guard top plate (26). Accordingly, the viewing slot (128) has an open end (128a) at the front end (26a) of the guard top plate (26) and extends to a closed end (128b) provided within the guard top plate (26). The viewing slot (128) has a maximum width of just less than one half inch, or approximately 12 mm, to allow for adequate viewing the cutting zone, including the saw blade (16) and the workpiece from above the guard top plate (26), while limiting the ability of the user to contact the saw blade (16) through the viewing slot (128).

The viewing slot (128) may include chamfered edges (130) that run along the length of the viewing slot (128). The angled faces (131) of the chamfered edges (130) point toward the top surface (26c) of the guard top plate (26). Alternatively, similar to the embodiment shown in FIG. 1, the chamfered edges (130) may be formed such that the angled faces (131) point toward the bottom surface of the guard top plate (26). The chamfered edges (130) on each side of the viewing slot (128) may be connected together at the closed end (128b) of the viewing slot (128) or they may be independent of each other. The chamfered edges (30, 130) may form an edge (26f) with the top surface (26c) of the guard top plate (26) (as shown in FIG. 1), or alternatively the chamfered edges (130) may form an edge (26f) with the bottom surface (26e) of the guard top plate (26), (as shown in FIG. 13a).

As best shown in FIG. 13a, the angled faces (131) of the chamfered edges (130) may form an edge (131a) with the viewing slot (128) at an intermediate portion on the height of the viewing slot (128) between the top surface (26b) and the bottom surface (not shown) of the guard top plate (26). In these embodiments as shown in FIG. 13b, the viewing slot (128) may have the maximum width (W1) of approximately, or slightly less than 0.5 inches (approximately 0.47 inches or 12 mm) between the chamfered edges (130) but may have a larger width (W2) in the portions of the viewing slot (128) above or below the chamfered edges (130).

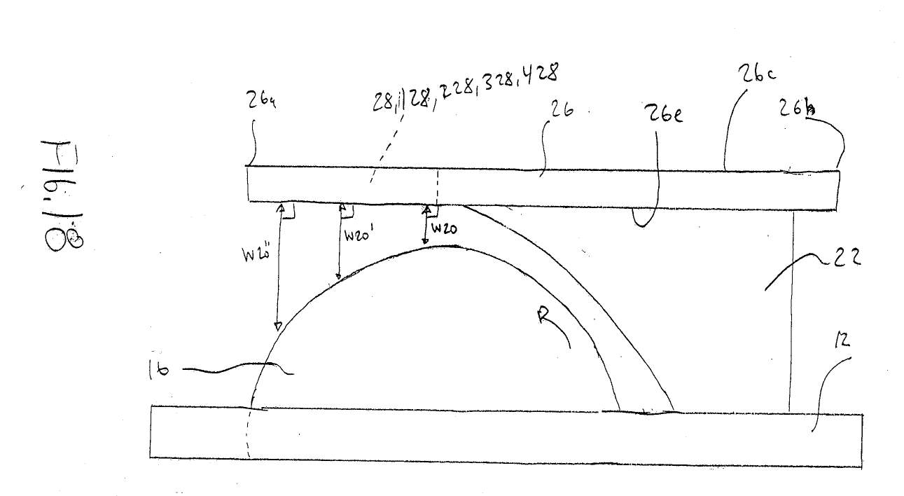

Alternatively with reference to FIG. 17, the viewing slot (128) may be oriented such that the maximum width (W1) between the chamfered edges (130) may be such that the smallest distance (W10, W10′, W10″) between viewing slot (128) at the bottom surface (26e) of the guard top plate (26) along the entire length of the viewing slot (128) and the saw blade (16) is at least three times greater than the width of the viewing slot (128) at the position where the distance (W10, W10′, W10″) from the saw blade (16) is measured. In other embodiments, the viewing slot may be oriented such that the maximum width (W1) may be such that the smallest distance (W10, W10′, W10″) between the viewing slot (128) at the bottom surface (26e) of the guard top plate (26) along the entire length of the viewing slot (128) and the saw blade (16) is at between two to ten times greater than the width of the viewing slot (128) at the position where the distance (W10, W10′, W10″) from the saw blade (16) is measured.

In still other embodiments, with reference to FIG. 18, the viewing slot (128) may be oriented such that the maximum width (W1) between the chamfered edges (130) may be such that the distance (W20, W20′, W20″) between the viewing slot (128) at the bottom surface (26e) of the guard top plate (26) along the entire length of the viewing slot (128) and the saw blade (16) measured perpendicularly to the longitudinal axis of the top plate (26) is at least three times greater than the width of the viewing slot (128) at the position where the distance (W20, W20′, 20″) from the saw blade (16) is measured. In other embodiments, the viewing slot may be oriented such that the maximum width (W1) may be such that the perpendicular distance (W20, W20′, W20″) between the viewing slot (128) at the bottom surface (26e) of the guard top plate (26) along the entire length of the viewing slot (128) and the saw blade (16) is at between two to ten times greater than the width of the viewing slot (128) at the position where the distance (W20, W20′, W20″) from the saw blade (16) is measured.

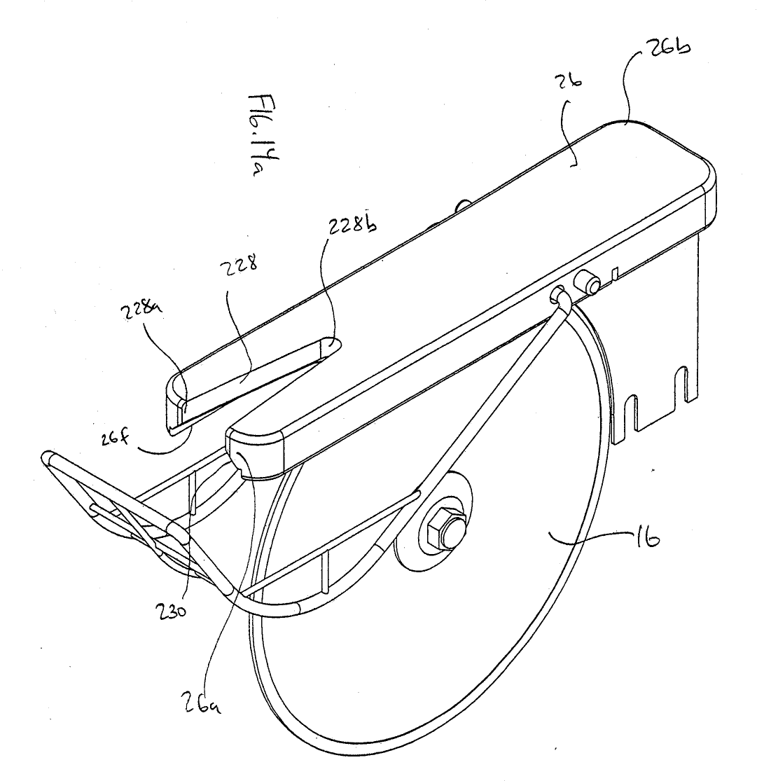

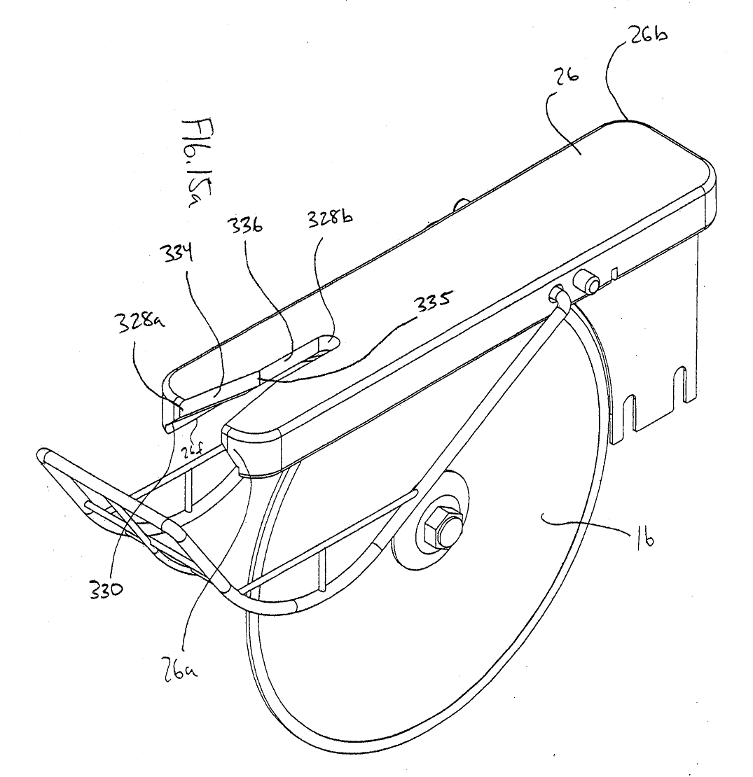

FIGS. 14a and 14b show a second alternate embodiment of a viewing slot (228) for the guard top plate (26). Specifically, the viewing slot (228) is formed with a tapered profile between the front end (26a) that extends toward the second end (26b) of the guard top plate (26). Specifically, the viewing slot (228) includes an open end (228a) that is formed with a first width (W3) between the opposing sides of the viewing slot (228). The width between the opposing sides of the viewing slot (228) decreases toward the closed end (228b) of the viewing slot (228). In some embodiments, the width (W3) at the open end (228a) of the viewing slot (228) may be approximately or slightly less than 0.5 inches (approximately 0.47 inches or 12 mm) and the width of the viewing slot (228) decreases toward the closed end (228b).

Alternatively, the width along the length of the viewing slot (228) may be either approximately or slightly less than 0.5 inches or less than ⅓ of the shortest distance (W10, W10′, W10″ as shown in FIG. 17) between the bottom surface (26e) of the guard top plate (26) and the saw blade (16) at all positions of the viewing slot (228). Still alternatively, the width along the length of the viewing slot (228) may be either approximately or slightly less than 0.5 inches or less than ⅓ of the perpendicular distance (W20, W20′, W20″, as shown in FIG. 18) at all positions of the viewing slot. The opposing surfaces of the viewing slot (228) may be planar or in other embodiments at least a portion of the opposing side surfaces of the viewing slot may be arcuate or formed with other geometries.

The viewing slot (228) may have chamfered edges (similar to element 130 of FIGS. 13a, 13b and elements 30 of FIG. 1) to aid the user in viewing the cutting zone including the saw blade (16) and the workpiece, while minimizing the width of the viewing slot (228). The chamfered edges on the viewing slot (228) may be provided on either the top surface (26c) of the guard top plate (26) or on the bottom surface (not shown) of the guard top plate (26), or the chamfered edges may be provided on both the top surface (26c) and the bottom surface (26e, FIG. 17) of the guard top plate (26).

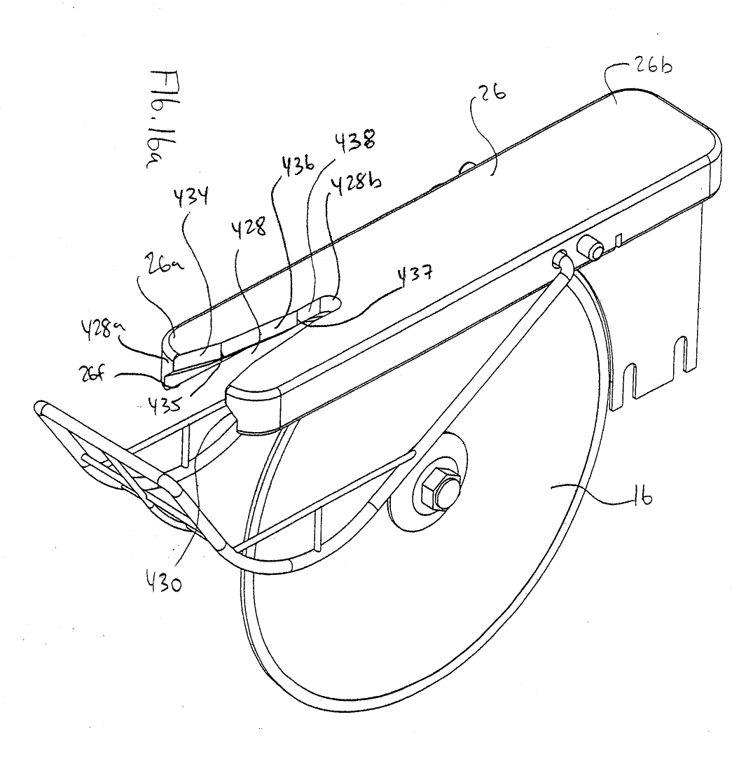

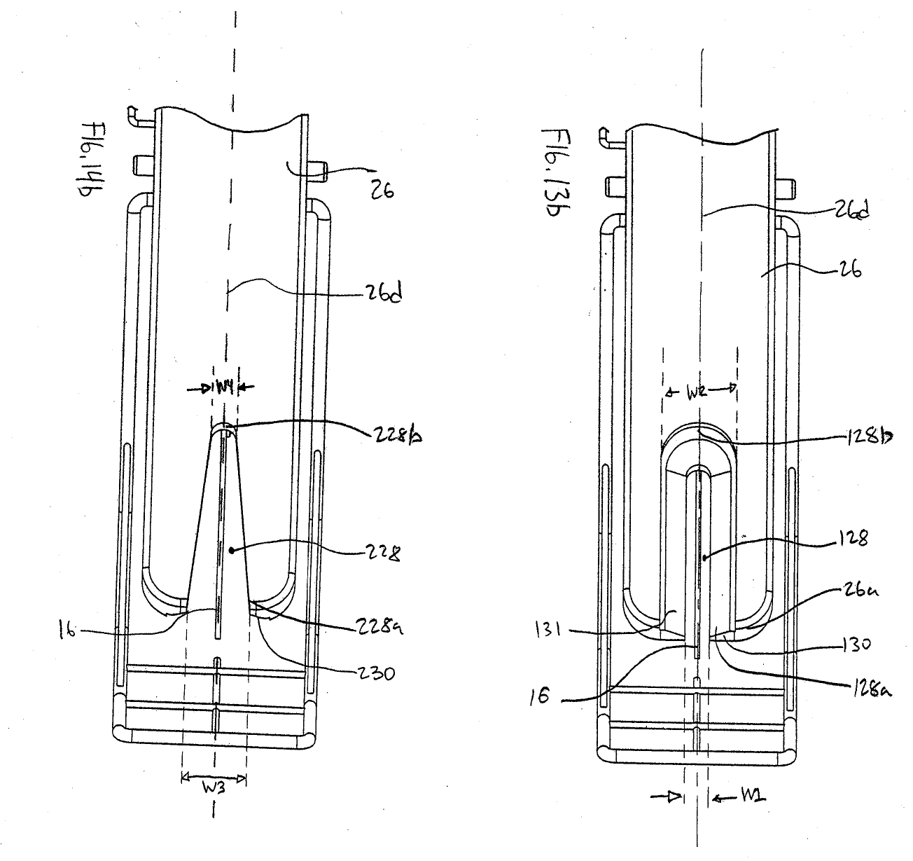

As shown in FIGS. 15a-15b, a third alternate embodiment of a viewing slot (328) for a guard top plate (26) is provided. The viewing slot (328) includes a first portion (334) that extends from the open end (328a) inward toward the closed end (328b) of the viewing slot (328) and a second portion (336) that intersects the first portion (334) at an intermediate position (335) and may have a constant width (W5) that extends to the closed end (328b) of the viewing slot (328). Accordingly, the second portion (336) may be substantially parallel to the longitudinal axis (26d) of the guard top plate (26). Preferably, the width (WS) of the second portion (336) is approximately or slightly less than 0.5 inches (i.e. 0.47 inches or 12 mm) to provide adequate viewing of the cutting zone, while minimizing contact with the saw blade (16) when approached from above the guard top plate (26). In other embodiments, the maximum width along the length of the viewing slot (228) may be approximately or slightly less than 0.5 inches (i.e. 0.47 inches or 12 mm).

Alternatively, with reference to FIG. 17, the viewing slot (328) may be oriented such that the smallest distance (W10, W10′, W10″) between each portion of the viewing slot (328) on the bottom surface of the guard top plate (26) and the saw blade (16) is at least three times greater than the minimum width of the viewing slot (328) at that position on the guard top plate (26) or approximately or slightly less than 0.5 inches (i.e. 0.47 inches or 12 mm). Further alternatively, with reference to FIG. 18, the viewing slot (328) may be oriented such that the perpendicular distance (W20, W20′, W20″) between each portion of the viewing slot (328) on the bottom surface of the guard top plate (26) and the saw blade (16) is at least three times greater than the minimum width of the viewing slot (328) at that position on the guard top plate (26) or approximately or slightly less than 0.5 inches (i.e. 0.47 inches or 12 mm).

The first portion (334) may have a width between the opposing surfaces of the viewing slot (328) that decreases from the open end (328a) to the intermediate position (335). The distance between the opposing surfaces of the first portion (334) of the viewing slot (328) may decrease linearly or in another suitable decreasing pattern. For example, the opposing surfaces of the viewing slot (328) may be arcuate such that the width decreases exponentially or in another manner. The viewing slot (328) may have chamfered edges (330) to aid the user in viewing the cutting zone including the saw blade (16) and the workpiece, while limiting the width between the opposing sides of the viewing slot (328).

The viewing slot (328) may include chamfered edges similar to those discussed with respect to viewing slots (28), (128), and (228). For the sake of brevity, a full description of the chamfered edges will not be repeated here.

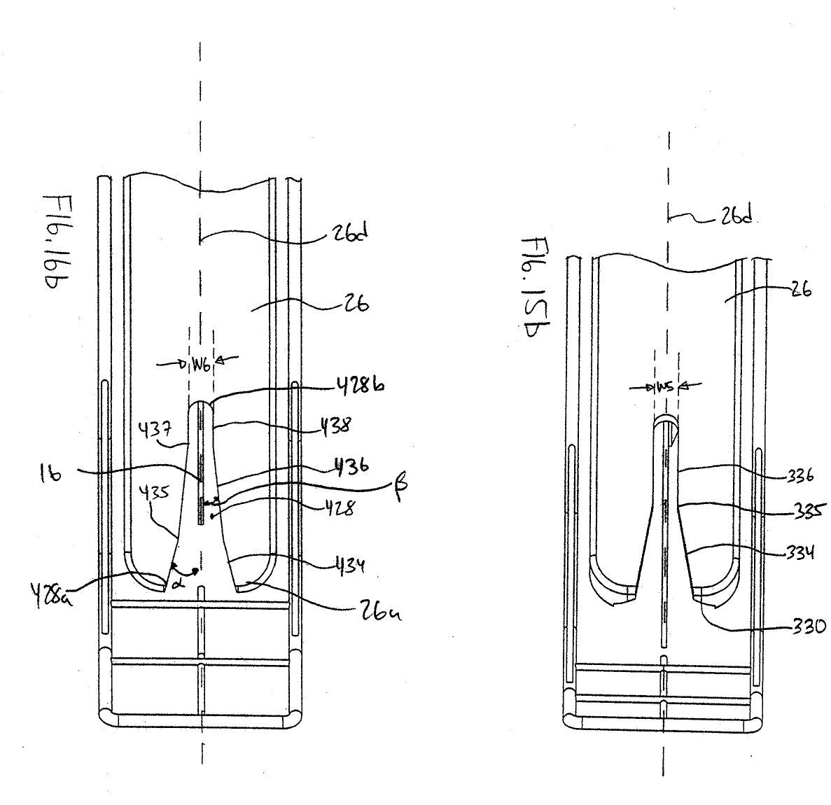

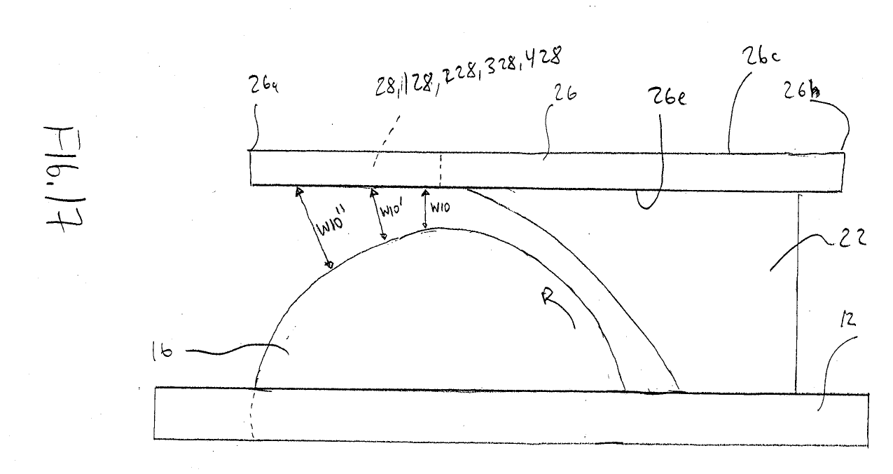

As shown in FIGS. 16a-16b, a fourth embodiment of a viewing slot (428) for a guard top plate (26) is provided. The viewing slot (428) includes a first section (434) that extends inward from the open end (428a) to a first intermediate point (435), a second intermediate section (436) that extends from the first intermediate point (435) to a second intermediate point (437), and a third section (438) that extends from the second intermediate point (437) to the closed end (428b) of the viewing sot (428). The third section (438) may be formed with a constant or a decreasing width between the opposing sides of the viewing slot (428) along the third section (438). The maximum width of the viewing slot (428) may be approximately or slightly less than 0.5 inches (12 mm) between the open end (428a) and the closed end (428b) or at least along the second and third sections (436), (438) or possibly only along the third section (438).

Alternatively with reference to FIG. 17, the viewing slot (428) may be oriented such that the smallest distance (W10, W10′, W10″) between each portion of the viewing slot (428) of the guard top plate (26) and the saw blade (16) is at least three times greater than the minimum width between the opposing surfaces of the viewing slot (428) at that position on the guard top plate (26) or the width of the viewing slot (228) is approximately or slightly less than 0.5 inches. Further alternatively, with reference to FIG. 18, the viewing slot (428) may be oriented such that the perpendicular distance (W20, W20′, W20″) between each portion of the viewing slot (428) on the bottom surface of the guard top plate (26) and the saw blade (16) is at least three times greater than the minimum width of the viewing slot (428) at that position on the guard top plate (26) or approximately or slightly less than 0.5 inches (i.e. 0.47 inches or 12 mm).

The viewing slot (428) may include chamfered edges similar to those discussed with respect to viewing slots (28), (128), and (228). For the sake of brevity, a full description of the chamfered edges will not be repeated here.

Each of the first and second sections (434, 436) include decreasing widths between the opposing surfaces of the viewing slot (428) as the sections move toward the closed end (438) of the viewing slot (428). The first section (434) may have a width that decreases at a greater rate than the rate of decreasing width of the second section (436) along the length of the respective section. In some embodiments, the opposing side surfaces of the first and second sections (434), (436) may be substantially planar and may form acute angles (α), (β), respectively with the longitudinal axis (26d) of the guard top plate (26). As understood with reference to FIG. 16b, the angle (α) between the opposing side surfaces of the first section (434) is larger than the angle (β) between the opposing side surfaces of the second section (436).

The saw blade (16) may be recessed in the guard (24), and specifically into the guard top plate (26). Thus, when the guard top plate (26) is placed just above the height of the workpiece to be cut, the blade (16) will automatically be at the correct height for the cut. Alternatively, as shown in FIG. 17, the guard top plate (26) may be mounted to the riving knife (12) such that the bottom surface (26e) of the guard top plate (26) is mounted just above the saw blade (16).

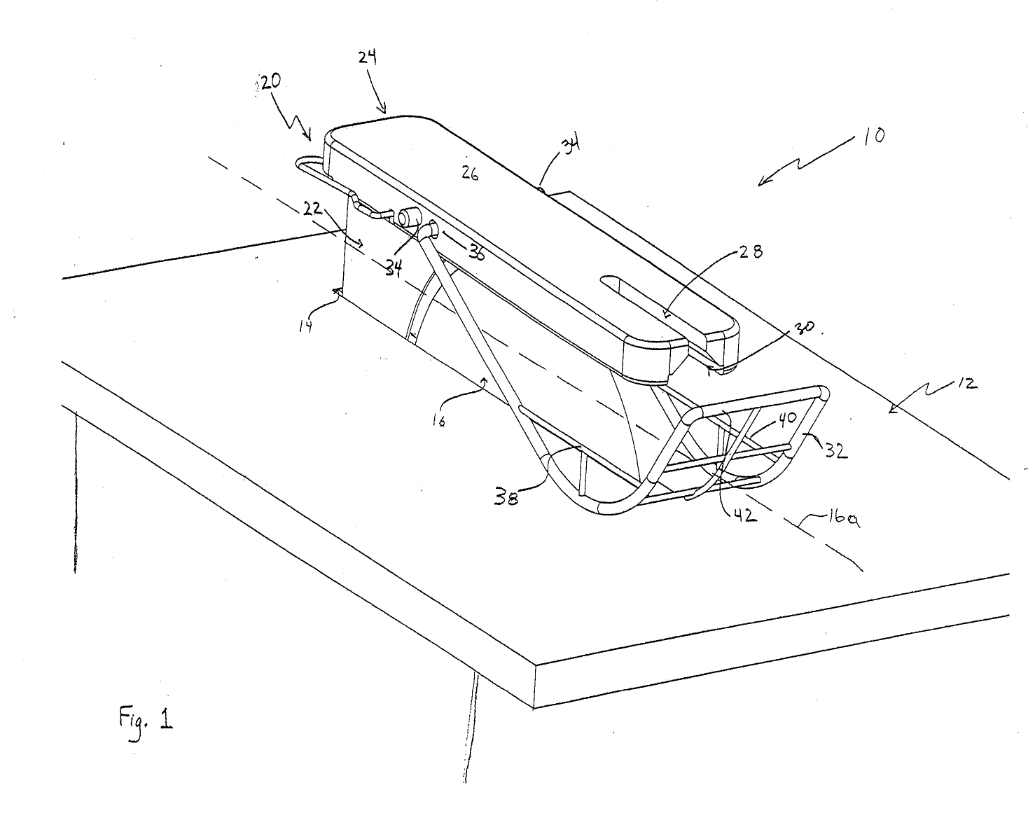

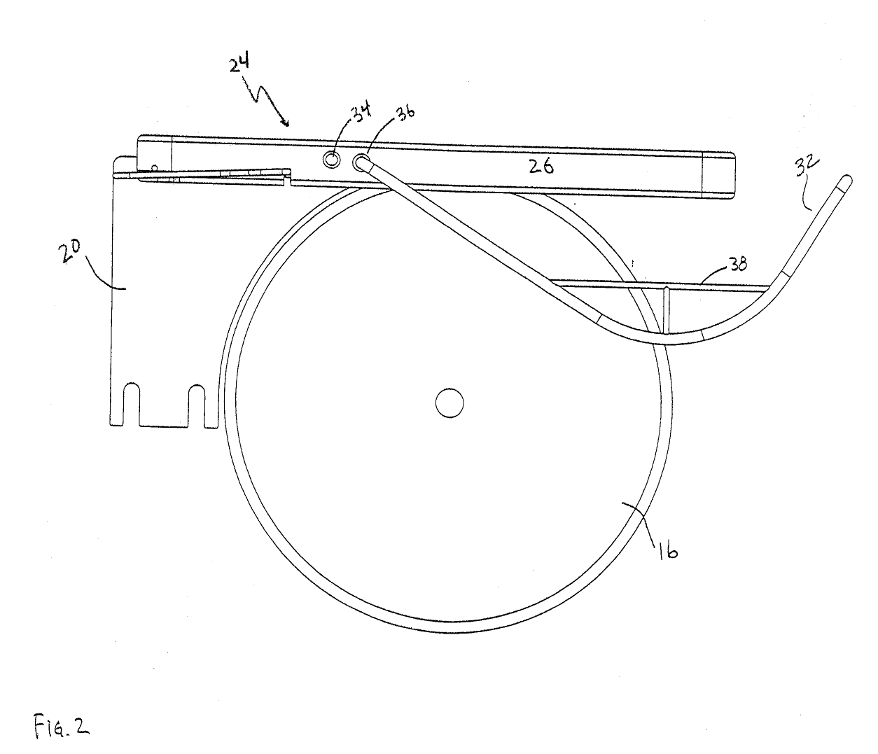

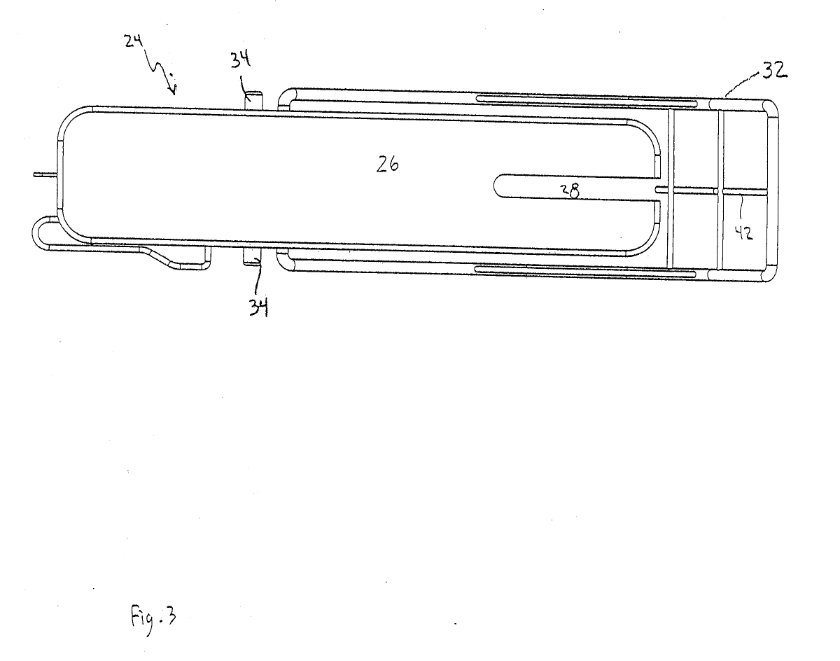

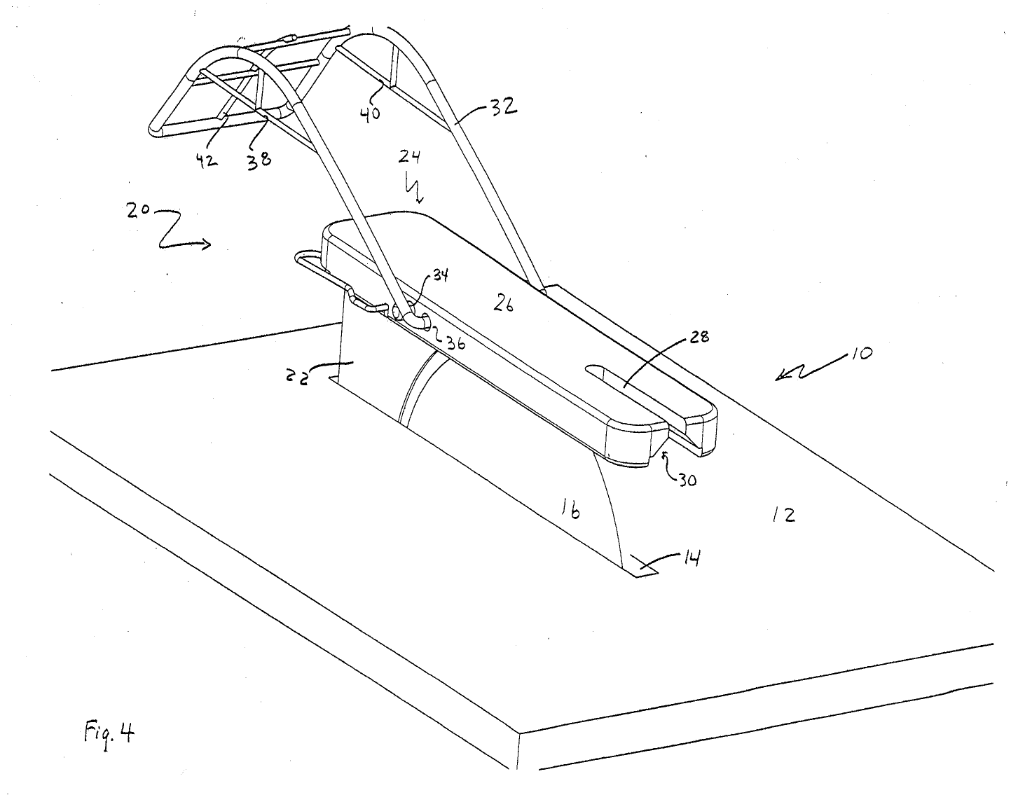

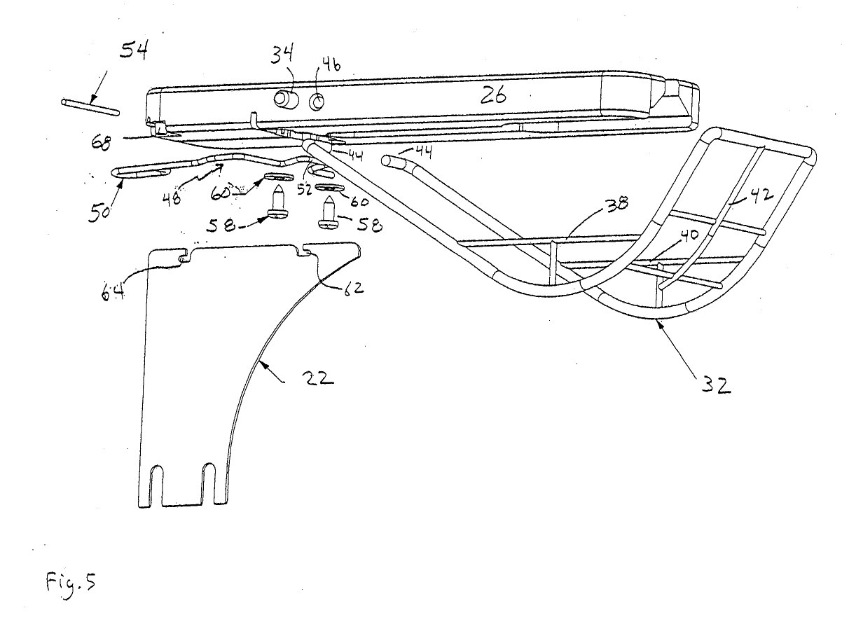

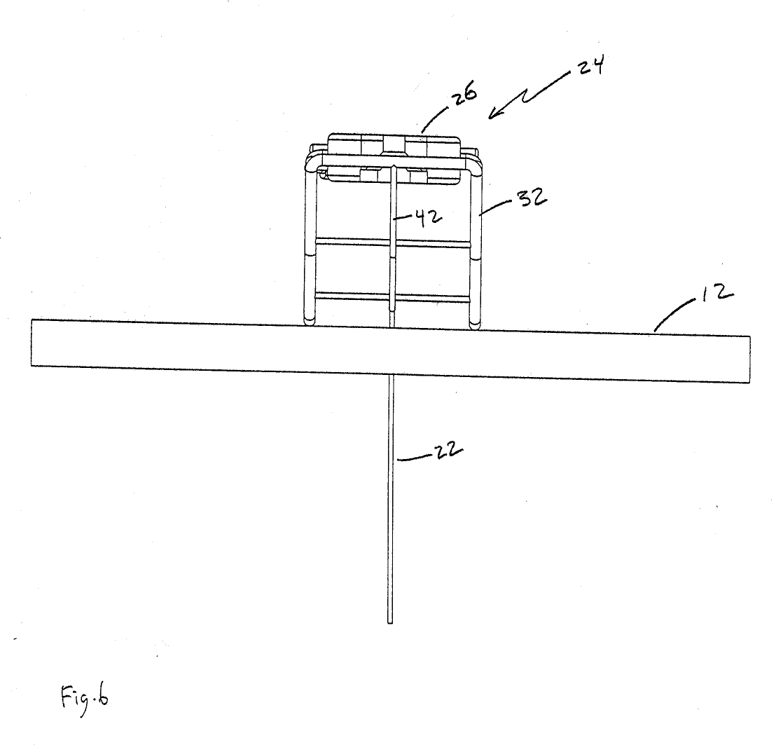

The guard (24) may also include a bail (32). The bail (32) is pivotally mounted (36) to the guard top plate (26). The bail is also shaped so that when the workpiece being cut is moved towards the blade (16), the bail (32) rides over the workpiece to allow the workpiece to move into the cutting zone. The combination of the bail's (32) shape along with the pivot mounting (36), allows for this to occur. The arc-shaped bail (32) shown in FIG. 1 will offer very little resistance when feeding the workpiece, and will also reduce the forces that tend to make the guard top plate (26) flex during use so that the guard top plate (26) does not hit the blade (16) or interfere with the cutting operation. As can best be seen in FIGS. 1, 2 and 5, the bail (32) has sides (38, 40) that extend beyond the sides of the guard top plate (26). The sides (38, 40) provide protection from the blade (16) both before and after the cut. Likewise, the bail (32) has a front portion (42) that will contact an operator's hands or fingers that are on top of the workpiece as it is fed to be cut, thus giving a warning that the operator's hands or fingers may be coming near the blade (16). The bail (32) is also designed not to interfere with measuring, aligning or setting up the workpiece due to its pivotal mounting (36). Specifically, as shown in FIG. 4, the bail (32) can be lifted and rotated back onto a pair of stops (34) located on either side of the guard top plate (26). The guard top plate (26) will remain in place even when the bail (32) is lifted into a raised or up position from its lowered or down position. As shown in FIG. 5, the bail (32) has stub ends (44) that fit into stub receiving orifices (46) (only one is shown) for pivotally mounting (36) the bail (32) to the guard top plate (26). The utilization of the stub ends (44) and stub receiving orifices (46) allows the bail (32) to be removed and attached to the guard top plate (26) without the use of any tools.

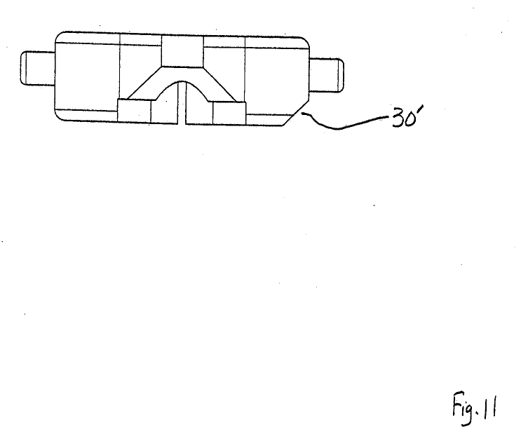

An alternate bail (32′) is shown in FIG. 12. The bail (32′) operates and functions similar to the bail (32) except that it is two distinct pieces. Specifically, bail 32′has a left side piece (70) and a right side piece (72). The two separate side pieces (70, 72) can be raised or lowered into the up or down position independently. This two-piece construction provides greater flexibility for adjustments and accommodating different size and shape workpieces.

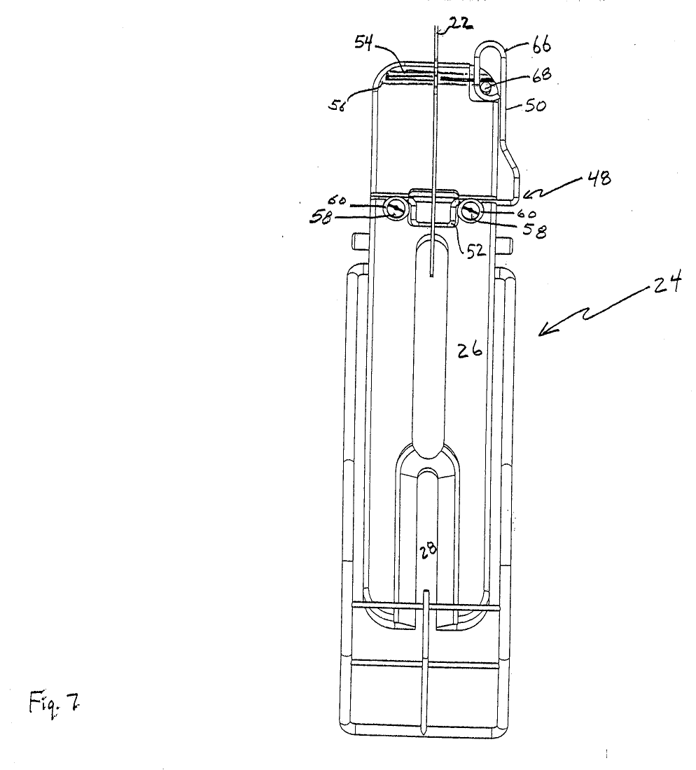

The guard (24) is mounted to the riving knife (22) through a system of pins and slots. FIG. 5 shows that in the preferred embodiment, two pins and two slots are used. The first pin is a multi-position pin (48) having a lever or arm (50) for adjusting the position of the multi-position pin (48). The multi-position pin (48) further includes a u-shaped or bent section (52) as best shown in FIGS. 5, 7 and 8. A second pin (54) is also used in the preferred embodiment. The second pin (54) is mounted to the guard top plate (26) in the preferred embodiment by press fitting the pin (54) into the bottom side of the guard top plate (26). Specifically, a channel (56) is provided at the back end (i.e., not the workpiece feed end) of the guard top plate (26), and the second pin (54) is press fit into the channel (56). Other methods for attaching the second pin (54) are also acceptable. As shown in FIGS. 5 and 7, the multi-position pin (48) is mounted to the bottom side of the guard top plate (26) through the use of two screws (58) and washers (60). Again, other methods for mounting the multi-position pin (48) are acceptable. The riving knife (22) includes slots (62, 64) for receiving the multi-position pin (50) and the second pin (54). The slots (62, 64) are dogleg shaped and are set in opposing directions as best shown in FIG. 5.

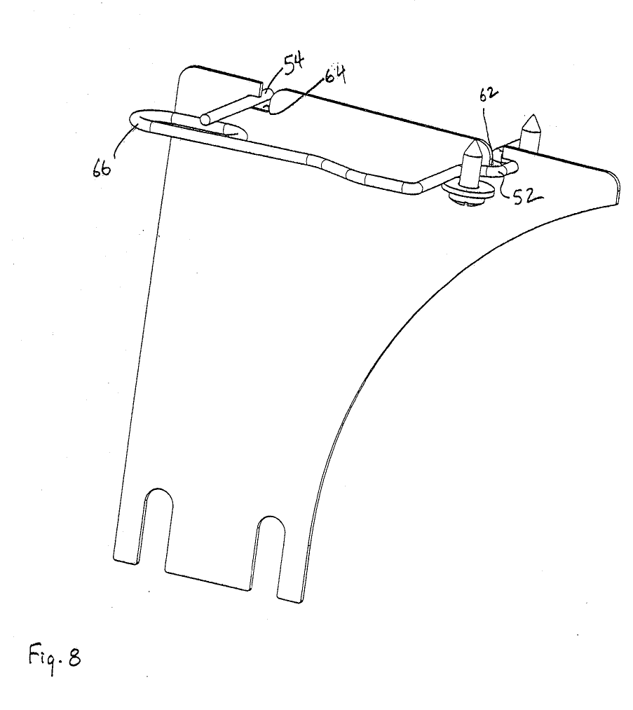

The multi-position pin (50) is capable of being moved into at least two positions. In a first or secure position, the guard (24) is securely mounted to the riving knife (22). The first position is clearly shown in FIG. 8. In the first position, the bent or u-shaped section (52) of the multi-position pin is secured in the dogleg portion of the slot (62). Likewise, the second pin (54) is also secured in the dogleg portion of the second slot (64). When in this position, pressure is exerted in the front, back, upward, and downward directions. As a result, the guard (24) is securely attached to the riving knife (22) and ready for operation. In the second or release position, the bent or u-shaped section (52) of the multi-position pin is generally located in the non-dogleg portion of the slot (62) and the pressure exerted during the first position is generally relieved. This allows the guard to be lifted, thus removing the multi-position pin (48) from slot (62) and the second pin (54) from slot (64). It is acceptable to reverse the positions of the multi-position pin (48) and the second pin (54) so that the multi-position pin (48) is located at the back end of the guard top plate (26) and the second pin (54) is located at the front end of the guard top plate (26).

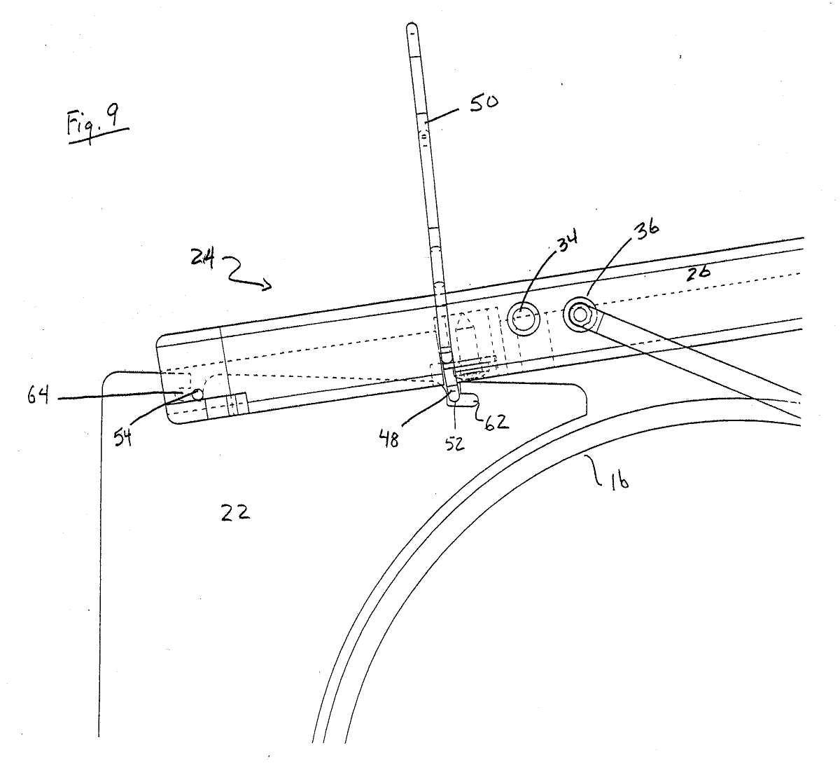

The guard (24) is capable of being attached to and removed from the riving knife (22) without the use of any tools. When attaching the guard (24) to the riving knife (22), the lever (50) initially should be in a vertical position so that it is perpendicular or near perpendicular to the guard top plate (26). When the lever (50) is in this position, the bent or u-shaped section (52) is also perpendicular or near perpendicular to the guard top plate (26) as shown in FIG. 9. The second pin (54) is placed in slot (64) and the bent or unshaped section (52) of multi-position pin (48) is placed in slot (62). The lever (50) is engaged downwardly toward the table top (12) to move the multi-position pin (48) to the first position. As the lever (50) is engaged, the bent or u-shaped section (52) is also rotated so that it moves into the dogleg section of slot (62). As the multi-position pin (48) moves into the dogleg slot (62), the guard (24) is forced toward the backside of the table saw (10) and the second pin (54) is moved into the dogleg section of slot (64). Thus, when the multi-position pin (48) is in the first position (as best shown in FIGS. 7 and 8), the guard (24) is securely attached to the riving knife (22). Additionally, the lever (50) may be secured by tucking the handle portion (66) of the lever (50) below the guard top plate (26) as shown in FIG. 7. A securing post (68) as shown in FIGS. 5 and 7 can be used to further aid in securing the lever (50) on the under side of the guard top plate (26) while the multi-position pin (48) is in the first position. Securing the lever (50) under the guard top plate (26) as well as use of the securing post (68) helps eliminate accidental disengagement of the multi-position pin (48) to the second position.

The multi-position pin (48) must be moved to the second position (described above and shown in FIG. 9) in order to be able to remove the guard (24) from the riving knife (22). Specifically, in the preferred embodiment, the multi-position pin (48) is moved to the second position by moving the lever (50) first in a downward direction, then horizontally outward, and finally upward. This motion places the multi-position pin (48) in the second position and allows the guard (24) to be removed from the riving knife (22). Of course, other lever motions are acceptable depending on whether any additional or different securing devices are used. For example, the securing post (68) could alternatively be mounted on the side of the guard top plate (26) and the lever (50) could be structured to engage a side mounted securing post. Many other alternatives are also available.

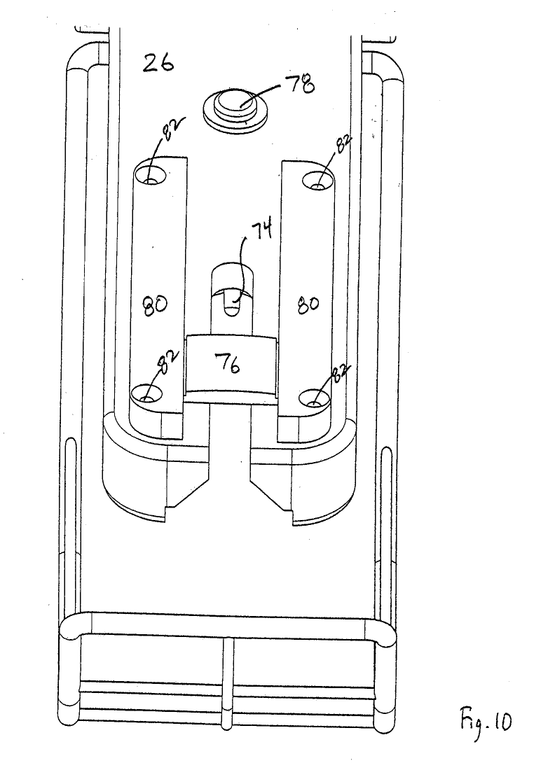

The guard (24) preferably may also include a light (74) and a magnifying lens (76) as shown in FIG. 10, although neither is required. The light (74) can be either incandescent, halogen, LED or any other acceptable light and is oriented to illuminate the cutting zone as well as the workpiece, saw blade (16) and any scale or alignment marks on the table top (12). The light (74) is mounted to the guard top plate (26) preferably in the viewing slot (28), and can be powered by wiring to the table saw (10) power source or through the use of a battery. The light (74) may be turned on and off with a switch or button (78), or may be directly wired to turn on and off in conjunction with turning on and off the saw blade (16).

The magnifying lens (76) is preferably adjustably mounted to top side of the guard top plate (26) through the use of guide rails (80) as shown in FIG. 10. The guide rails (80) in FIG. 10 are fastened to the guard top plate (26) by recessed screws (82). However, other methods for forming the guide rails (80) are acceptable such as gluing, or molding the guide rails (80) directly into the guard top plate (26). The guide rails (80) may also be located at different sections of the guard top plate (26) such as in the middle or lower portions. The guide rails (80) allow the position of the magnifying lens (76) to be adjusted by sliding the lens (76) in the guide rails (80). The magnifying lens (76) can provide an enlarged view of the cutting zone as well as the workpiece, the blade (16) and the scale or alignment marks on the table top (12). This will aid in improved set up for the cut.

The guard (24) may also be used in an active guard system. Specifically, the guard top plate (26) or the bail (32) could become part of a touch system that sets off audio or visual alarms to prevent injury. The active system could also activate a brake to stop the blade (16) or cut the power to the motor that drives the blade (16). The operation and design of an active touch system is described in pending U.S. provisional patent application Ser. No. 60/444,263 (filed on Jan. 31, 2003), which is hereby incorporated herein by reference.

Finally, the guard (24) also could have a vacuum port incorporated in the guard top plate (26). The port is attached to a vacuum source and will remove any dust or other loose matter that gathers under the guard top plate (26). This vacuum will prevent the accumulation of wood dust from cutting and will make clean up easier and quicker.

The foregoing disclosure is the best mode devised by the inventors for practicing this invention. It is apparent, however, that apparatus incorporating modifications and variations will be obvious to one skilled in the art. Inasmuch as the foregoing disclosure is intended to enable one skilled in the pertinent art to practice the instant invention, it should not be construed to be limited thereby but should be construed to include aforementioned obvious variations and be limited only by the spirit and scope of the following claims.

It is therefore intended that the foregoing detailed description be regarded as illustrative rather than limiting, and that it be understood that it is the following claims, including all equivalents, that are intended to define the spirit and scope of this invention.

1. A table saw comprising:
(a) a table top including a blade slot with a blade axis, the blade slot capable of receiving a saw blade; and
(b) a guard comprising a guard top plate that includes a viewing slot, wherein the viewing slot is defined with a first open end at a front portion of the guard top plate and extends toward a rear portion of the guard top plate to define a second enclosed end, the viewing slot comprises a plurality of chamfered edges with an angled face that extend along the length of the viewing slot.

2. The table saw of claim 1, wherein the viewing slot comprises a first portion located between the chamfered edges with a first width and a parallel second portion with a second width greater than the first width.

3. The table saw of claim 2, wherein the first portion is defined by opposing innermost ends of the chamfered edges along the length of the viewing slot.

4. The table saw of claim 2, wherein the second portion extends along at least a portion of the length of the viewing slot and forms a second edge with a top surface of the guard top plate, and the first portion extends along at least a portion of the length of the viewing slot and forms a first edge with a bottom surface of the guard top plate.

5. The table saw of claim 1, wherein the chamfered edges are continuous along a perimeter of the entire viewing slot.

6. The table saw of claim 2, wherein the first width is approximately 0.5 inches along the length of the viewing slot between the first and second ends.

7. A table saw comprising:
(a) a tabletop including a blade slot;
(b) a saw blade having a blade axis and extending through the blade slot; and
(c) a guard comprising a guard top plate with a longitudinal axis, the guard top plate comprising a viewing slot with a first open end located at a front portion of the guard top plate, and a second enclosed end defined within the guard top plate, wherein the viewing slot has a first width at the first end and a smaller second width at the second end.

8. The table saw of claim 7, wherein the viewing slot includes two opposite side surfaces that extend from the first end to the second end of the viewing slot.

9. The table saw of claim 8, wherein the two side surfaces are planar between the first and second ends.

10. The table saw of claim 8, wherein each of the two side surfaces include at least one arcuate portion.

11. The table saw of claim 7, wherein the viewing slot further comprises a first portion extending from the first end of the viewing slot toward the second end, and a second portion intersecting the first portion and extending toward the second end of the viewing slot.

12. The table saw of claim 11, wherein each of the first portion and the second portion are defined by two opposing side surfaces, wherein the two opposing side surfaces in each of the first and second portions are planar.

13. The table saw of claim 12, wherein each of the side surfaces of the second portion of the viewing slot are substantially parallel to the blade axis.

14. The table saw of claim 13, wherein each of the opposing side surfaces of the first portion of the viewing slot is provided at an acute angle with respect to the longitudinal axis of the guard.

15. The table saw of claim 13, wherein each of the opposing side surfaces of the first portion of the viewing slot is at an acute angle with respect to the blade axis.

16. The table saw of claim 12, wherein each of the opposing side surfaces of the second portion of the viewing slot are provided at an acute angle with respect to the longitudinal axis of the guard, and each of the opposing side surfaces of the first portion of the viewing slot are provided at a larger acute angle with respect to the longitudinal axis of the guard.

17. The table saw of claim 11, further comprising a third portion of the viewing slot intersecting the second portion and extending toward the second end of the viewing slot.

18. The table saw of claim 17, wherein the third portion is parallel to the longitudinal axis of the guard.

19. The table saw of claim 17, wherein each of the opposing side surfaces of the third portion are at an acute angle with respect to the longitudinal axis of the guard that are smaller than an acute angle between the opposing side surfaces of the second portion and the longitudinal axis.

20. The table saw of claim 7, wherein the viewing slot is sized such that the width between the opposing surfaces of the viewing slot is either approximately 0.5 inches, or is such that the smallest distance between a bottom surface of the guard top plate along the viewing slot is at least three times greater than a minimum width between the opposing surfaces of the viewing slot at the same position along the viewing slot.

21. The table saw of claim 7, wherein the viewing slot further comprises a chamfered edge that extends along at least a portion of the length of the viewing slot between the first and second ends.

22. A table saw comprising:
(a) a table top including a blade slot with a blade axis, the blade slot capable of receiving a saw blade; and
(b) a guard comprising a guard top plate that includes a viewing slot, wherein the viewing slot is defined with a first open end at a front portion of the guard top plate and extends toward a rear portion of the guard top plate to define a second enclosed end, wherein the viewing slot is sized such that a maximum width between opposing surfaces of the viewing slot is either approximately 0.5 inches, or is such that the smallest distance between a bottom surface of the guard top plate along the viewing slot is at least three times greater than a minimum width between the opposing surfaces of the viewing slot at the same position along the viewing slot.
